(19) United States
(12) Patent Application Publication
(10) Pub. No.: US 2026/0209570 A1
(43) Pub. Date: Jul. 23, 2026

(54) ADHESIVE COMPOSITION, ADHESIVE SHEET, PROTECTIVE FILM, AND DISPLAY DEVICE INCLUDING SAME

(71) Applicant: DONGWOO FINE-CHEM CO., LTD., Iksan-si (KR)

(72) Inventors: Hye-Rim KWON, Iksan-si (KR); Jin-Woo LEE, Iksan-si (KR); In-Oh HWANG, Iksan-si (KR)

(73) Assignee: DONGWOO FINE-CHEM CO., LTD., Iksan-si (KR)

(21) Appl. No.: 19/451,255

(22) Filed: Jan. 16, 2026

(30) Foreign Application Priority Data
Jan. 17, 2025 (KR) 10-2025-0007210

(51) Int. Cl. C09J 7/38; C08G 18/62; C08G 18/76; C08K 5/00; C09J 133/06

(52) U.S. Cl. CPC C09J 7/385; C08G 18/6229; C08G 18/76; C08K 5/0091; C09J 133/066; C09J 2301/302; C09J 2433/00

(57) ABSTRACT

The present disclosure relates to an adhesive composition more suitable for a foldable and/or flexible display, an adhesive sheet including the same, and a foldable and/or flexible display including the same. In particular, an adhesive sheet manufactured using the adhesive composition of the present disclosure may be attached to a lower surface of a transparent substrate having a water contact angle of 100° or more and used in the form of a protective film. Since the pressure-sensitive adhesive sheet exhibits adhesive strength and is easily re-peelable, when lifting or fracture occurs at a folding portion of a foldable display, replacement of the protective film is possible while minimizing damage to the product. Furthermore, the adhesive sheet has excellent folding properties, thereby enhancing reliability. Accordingly, the present disclosure relates to such an adhesive composition, an adhesive sheet, a protective film, and a foldable and/or flexible display including the same.

### CROSS-REFERENCE TO RELATED APPLICATION(S)

This application claims the benefit under 35 USC 119(a) of Korean Patent Application No. KR 10-2025-0007210, filed on Jan. 17, 2025 with the Korean Intellectual Property Office, the disclosure of which is incorporated herein by reference in its entirety.

### BACKGROUND

### 1. Technical Field

The present disclosure relates to an adhesive composition, an adhesive sheet manufactured using the same, and a display including the same.

### 2. Related Art

With the advancement of technology, touch screens or touch panels used in the display industry are increasingly shifting toward flexible forms. Since flexible display devices themselves are bent, rolled, and folded, the display panels and optical films included in the devices are also subjected to bending stress. Accordingly, adhesives used in flexible displays are required to have enhanced and diversified properties. Therefore, adhesives used to attach transparent films or ultra thin glass (UTG) to such touch screens or touch panels require folding properties along with adhesive properties to various substrates.

For example, adhesives used in foldable display devices are required to have excellent folding characteristics to enable flexible folding of the device. Particularly, considering cases in which the foldable display devices are used for a long period of time outdoors in a low-temperature state, it is desirable for the adhesives to have excellent folding characteristics at low temperatures. In the case of an adhesive composition used for a foldable display, when the elastic modulus is excessively high, the force suppressing the restoring force of a step is reduced, which may hinder folding properties. Thus, it is required to satisfy an appropriate elastic modulus and recovery rate.

Meanwhile, Korean Patent Laid-Open Publication No. 10-2014-0136265 discloses an adhesive composition for a touch panel including a hydroxyl group-containing monomer, a carboxyl group-containing monomer, or a nitrogen-containing monomer as a functional monomer of the composition. However, when the adhesive is used in a foldable display operated in a folding form, there are problems in that the adhesive sheet is fractured, lifted, or wrinkled. Such problems may result from the fact that the nitrogen-containing monomer excessively increases the elastic modulus, failing to suppress fracture, lifting, and wrinkling. Therefore, for flexible displays, which require more frequent replacement of protective films compared to general displays, there is a demand for the development of an adhesive composition for manufacturing an adhesive sheet that not only has adhesive strength allowing easy re-peeling but also improves folding properties, especially when used in foldable displays, by controlling the low-temperature elastic modulus and recovery rate.

In addition, an adhesive sheet manufactured using an adhesive for a foldable display device is required to have excellent adhesive strength as well as excellent folding properties. For example, a fluorine-coated protective film is generally attached to protect the cover window of a foldable display. When lifting of the film occurs at a folding portion while an end consumer is using the product, peeling and re-attachment are required. In this case, when an adhesive sheet that does not allow easy re-peeling is applied to the protective film, a problem may occur in the durability of the product.

Meanwhile, when resin products included in flexible displays, such as base films, base sheets, or base substrates formed of resin, are used, it is necessary to use an adhesive between the resin products for purposes such as fixing the base sheet for a display element and an optical film laminate or the protective film. However, conventional acrylic adhesives have problems such as insufficient adherence to these resin products or failure to satisfy re-peelability. In particular, fluorine-coated films having a water contact angle of 100° have poor compatibility with general-purpose adhesives or adhesive layers formed therefrom, and have a drawback of difficult adherence, making practical application difficult. Therefore, there is a demand for an adhesive composition, an adhesive sheet, and the like having good adherence to resin products.

### PRIOR ART LITERATURE

### Patent Documents

(Patent Document 1) Korean Patent Laid-Open Publication No. 10-2014-0136265

### SUMMARY

The present disclosure has been made to improve the problems of the prior art described above, and an object thereof is to provide an adhesive composition suitable for foldable and/or flexible displays, which is easy to re-peel, has excellent adhesive strength, and has controlled recovery rate and low-temperature elastic modulus so as to particularly improve folding properties, and an adhesive sheet manufactured therefrom.

Another object of the present disclosure is to provide an adhesive composition capable of manufacturing an adhesive sheet having excellent adherence to a substrate having a water contact angle of 100° or more, including fluororesin, etc.

Still another object of the present disclosure is to provide a protective film including the adhesive sheet.

Yet another object of the present disclosure is to provide a display device including the adhesive sheet.

However, the problems to be solved by the present disclosure are not limited to the above-mentioned problems, and other problems not mentioned will be clearly understood by those skilled in the art from the following description.

The present disclosure relates to an adhesive composition including: A) an acrylic copolymer, and B) a crosslinking agent, wherein the A) acrylic copolymer includes a linear or branched alkyl (meth)acrylate monomer having 8 to 30 carbon atoms in an amount of 73 to 94.99 wt % based on the total weight of the acrylic copolymer, the B) crosslinking agent includes at least one selected from an isocyanate crosslinking agent and a metal chelate crosslinking agent in an amount of 0.001 to 2 parts by weight based on 100 parts by weight of the acrylic copolymer, and the A) acrylic copolymer does not include an amine monomer.

In the present disclosure, the isocyanate crosslinking agent may be at least one selected from the group consisting of tolylene diisocyanate, xylene diisocyanate, hexamethylene diisocyanate, 2,4-diphenylmethane diisocyanate, 4,4-diphenylmethane diisocyanate, isophorone diisocyanate, tetramethylxylene diisocyanate, naphthalene diisocyanate, and isocyanurate trimers.

In the present disclosure, the metal chelate crosslinking agent may include at least one selected from zirconium, aluminum, zinc, manganese, and magnesium.

In the present disclosure, the metal chelate crosslinking agent may be at least one selected from the group consisting of aluminum triacetylacetonate, zirconium tetrakis(acetylacetonate), diisopropoxyaluminum monooleyl acetoacetate, zinc acetylacetone, magnesium acetylacetone, and manganese triacetylacetonate.

In the present disclosure, the linear or branched alkyl (meth)acrylate monomer having 8 to 30 carbon atoms may be at least one selected from the group consisting of ethylhexyl acrylate (2-EHA), 2-dodecyl-1-hexadecenyl acrylate (DHD-A), 2-decyl-1-tetradecenyl acrylate (DTD-A), lauryl acrylate, and stearyl acrylate.

In the present disclosure, the A) acrylic copolymer may include an acid-containing (meth)acrylate monomer in an amount of 0.01 to 2 wt % based on the total weight of the acrylic copolymer.

In the present disclosure, the A) acrylic copolymer may include a hydroxyl group-containing (meth)acrylate monomer in an amount of 5 to 25 wt % based on the total weight of the acrylic copolymer.

In the present disclosure, the hydroxyl group-containing (meth)acrylate monomer may be 4-hydroxybutyl acrylate (4-HBA).

The present disclosure relates to an adhesive sheet manufactured by coating the adhesive composition onto a base film.

In the present disclosure, the adhesive sheet may have an adhesive strength of 100 to 300 gf/inch as measured at 23° C. and 50% RH after being bonded to a substrate having a water contact angle of 100° or more.

In the present disclosure, the adhesive sheet may have an elastic modulus of 30 to 300 kPa at −20° C.

The present disclosure relates to a protective film including the adhesive sheet of the present disclosure and a transparent substrate having a water contact angle of 100° or more.

The present disclosure relates to a display device including an adhesive sheet formed from the adhesive composition.

In the present disclosure, the display device may be a foldable display device.

According to the present disclosure, the adhesive composition includes an acrylic copolymer that does not contain an amine group-containing monomer, and an isocyanate crosslinking agent or a metal chelate crosslinking agent, and thus, can have improved folding properties due to a low low-temperature elastic modulus and excellent recovery rate, while also enabling excellent adhesive strength to a substrate having a water contact angle of 100° or more and easy re-peeling by appropriately controlling the crosslinking density.

Furthermore, according to the present disclosure, since A) the acrylic copolymer includes a linear or branched alkyl (meth)acrylate monomer having 8 to 30 carbon atoms in an amount of 73 to 94.99 wt % based on the total weight of the acrylic copolymer, the adhesive composition can maintain a low elastic modulus after curing, thereby improving folding properties.

When the adhesive composition according to the present disclosure is applied and cured on a substrate having a water contact angle of 100° or more, it is possible to manufacture an adhesive sheet having an adhesive strength of 100 to 300 gf/inch and/or an elastic modulus of 30 to 300 kPa at −20° C.

By applying the adhesive composition and the adhesive sheet according to the present disclosure, a protective film that is easily re-peelable can be provided.

By applying the adhesive composition and the adhesive sheet according to the present disclosure, a flexible display device having excellent folding properties can be provided.

### DETAILED DESCRIPTION

The present disclosure relates to an adhesive composition more suitable for a foldable and/or flexible display, an adhesive sheet including the same, and a foldable and/or flexible display including the same. More preferably, in the present invention, the adhesive composition and the adhesive sheet may be a pressure-sensitive adhesive composition and a pressure-sensitive adhesive sheet. In particular, an adhesive sheet manufactured using the adhesive composition of the present disclosure may be attached to a lower surface of a transparent substrate having a water contact angle of 100° or more and used in the form of a protective film. Since the adhesive sheet exhibits excellent adherence to the transparent substrate and is easily re-peelable, when lifting or fracture occurs at a folding portion of a foldable display, replacement of the protective film is possible while minimizing damage to the product. Furthermore, the adhesive sheet has excellent folding properties, thereby enhancing reliability. Accordingly, the present disclosure relates to such an adhesive composition, an adhesive sheet, and a foldable and/or flexible display including the same.

Hereinafter, the present disclosure will be described in more detail. However, the terms used in the specification are for the purpose of describing embodiments and are not intended to limit the present disclosure. In the specification, the adhesive sheet may be intended to include an adhesive (layer) and a base film.

In the present disclosure, the term “(meth)acrylate” means “acrylate” or “methacrylate.”

The present disclosure relates to an adhesive composition including: A) an acrylic copolymer, and B) a crosslinking agent, wherein the A) acrylic copolymer includes a linear or branched alkyl (meth)acrylate monomer having 8 to 30 carbon atoms in an amount of 73 to 94.99 wt % based on the total weight of the acrylic copolymer, the B) crosslinking agent includes at least one selected from an isocyanate crosslinking agent and a metal chelate crosslinking agent in an amount of 0.001 to 2 parts by weight based on 100 parts by weight of the acrylic copolymer, and the A) acrylic copolymer does not include an amine monomer. According to the present disclosure, unlike conventional technologies, the adhesive composition includes an acrylic copolymer that does not contain an amine group-containing monomer, and an isocyanate crosslinking agent or a metal chelate crosslinking agent, and thus, can have improved folding properties due to a low low-temperature elastic modulus and excellent recovery rate, while also enabling excellent adhesive strength and easy re-peeling by appropriately controlling the crosslinking density.

The adhesive sheet manufactured from the adhesive composition of the present disclosure can satisfy an adhesive strength of 100 to 300 gf/inch after curing or an elastic modulus of 30 to 300 KPa at −20° C., thereby exhibiting excellent adhesive strength and significantly improved folding properties. Accordingly, the adhesive composition of the present disclosure may be intended for manufacturing the above-described adhesive sheet.

In the present disclosure, the adhesive strength may be adhesive strength when bonded to a substrate having a water contact angle of 100° or more, and more specifically, adhesive strength measured at 20° C. to 25° C. and 30% to 80% RH after the adhesive sheet of the present disclosure is bonded to a transparent substrate having a water contact angle of 100° or more.

The substrate having a water contact angle of 100° or more is not particularly limited, and may be a fluorine-coated transparent substrate such as PET. Such a substrate has a problem in that it does not exhibit sufficient adherence strength to conventional adhesive layers or is difficult to re-peel, but with respect to the adhesive sheet of the present disclosure, exhibits an adhesive strength of 100 to 300 gf/inch, thereby securing adherence and re-peelability suitable for a replaceable protective film for preventing damage to a display.

In addition, it is also possible to manufacture a protective film suitable for a foldable or flexible display by bonding the adhesive sheet to a lower surface of a transparent substrate having a water contact angle of 100° or more on one surface thereof.

### <Adhesive Composition>

In the adhesive composition of the present disclosure, monomers included in an acrylic copolymer corresponding to a crosslinkable material are not particularly limited as long as they are polymerized into a polymer and crosslinked. Preferably, the monomers may be compounds having one or more unsaturated double bonds, and acrylic monomers or the like may be used to form an acrylic copolymer. However, in order for the adhesive composition of the present disclosure to be applied to a foldable and/or flexible display, it is more preferable that the acrylic copolymer does not include an amine monomer. The amine monomer refers to a monomer containing an amine group. When an amine monomer is included to improve heat resistance and elastic modulus of a copolymer as in the conventional art, the low-temperature elastic modulus increases, which may cause lifting during folding, thereby exhibiting characteristics that are particularly unsuitable for use in foldable displays.

### A) Acrylic Copolymer

The acrylic copolymer of the present disclosure includes a linear or branched alkyl (meth)acrylate monomer having 8 to 30 carbon atoms, and may further include at least one of an acid-containing (meth)acrylate monomer and a hydroxyl group-containing (meth)acrylate monomer. The acrylic copolymer of the present disclosure does not include an amine monomer.

a. Linear or Branched Alkyl (Meth)Acrylate Monomer Having 8 to 30 Carbon Atoms

The acrylic copolymer of the present disclosure may be obtained by polymerizing monomers including a linear or branched alkyl (meth)acrylate monomer having 8 to 30 carbon atoms. The linear or branched alkyl (meth)acrylate monomer having 8 to 30 carbon atoms is not particularly limited as long as it is a linear or branched alkyl (meth)acrylate monomer having 8 to 30 carbon atoms, wherein the ‘(meth)acrylate’ refers to both acrylate and methacrylate. The linear or branched alkyl (meth)acrylate monomer having 8 to 30 carbon atoms may be selected from the group consisting of 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate, 2-decyl tetradecyl (meth)acrylate, 2-dodecyl hexadecyl (meth)acrylate, lauryl acrylate, and stearyl acrylate. According to exemplary embodiments, ethylhexyl acrylate (2-EHA), 2-dodecyl-1-hexadecenyl acrylate (DHD-A), 2-decyl-1-tetradecenyl acrylate (DTD-A), lauryl acrylate, and stearyl acrylate may be used. These may be used alone or in combination of two or more thereof.

The linear or branched alkyl (meth)acrylate monomer having 8 to 30 carbon atoms is preferably included in an amount of 73 to 94.99 wt % based on the total weight of the acrylic copolymer. By including the linear or branched alkyl (meth)acrylate monomer having 8 to 30 carbon atoms in an amount within the above range, the elastic modulus after thermal curing can be maintained at a low level and an increase in elastic modulus after photocuring can be suppressed, thereby exhibiting the effects of good folding properties at room temperature and low temperature and excellent adhesive strength during manufacture of an adhesive sheet. When the content exceeds the above range, a problem of reduced folding properties at low temperature may occur, and when the content is below the above range, contamination of an adherend due to residues after peeling caused by low molecular weight components may occur.

b. Acid-Containing (Meth)Acrylate Monomer

The acrylic copolymer of the present disclosure may be obtained by polymerizing monomers further including a monomer having a crosslinkable acid.

The acid-containing (meth)acrylate monomer is not particularly limited as long as it reacts with a crosslinking agent to impart cohesive strength or adhesion strength through chemical bonding so as to prevent cohesive failure of the adhesive under high temperature or humidity conditions.

In one or more embodiments, the acid-containing (meth)acrylate monomer may include at least one selected from a sulfonic acid group-containing monomer, a phosphoric acid group-containing monomer, a carboxyl group-containing monomer, and an acid anhydride group-containing monomer.

The carboxyl group-containing monomer may be selected, for example, from the group consisting of monoacids such as (meth)acrylic acid, crotonic acid, isocrotonic acid, carboxyethyl (meth)acrylate, and carboxypentyl (meth)acrylate; diacids such as maleic acid, itaconic acid, and fumaric acid; and monoalkyl esters thereof, and is most preferably (meth)acrylic acid.

The acid-containing monomer is preferably included in an amount of 0.01 to 5 wt %, and more preferably 0.01 to 2 wt %, based on the total weight of A) the acrylic copolymer. When the acid-containing monomer is included in an amount within the above range, an acrylic polymer having a sufficient molecular weight is formed, thereby providing advantages of ensuring a desirable adhesive strength and improving the durability of the adhesive sheet.

c. Hydroxyl Group-Containing (Meth)Acrylate Monomer

The acrylic copolymer of the present disclosure may be obtained by polymerizing monomers further including a monomer having a hydroxyl group. The hydroxyl group-containing (meth)acrylate monomer can lower the storage modulus of the adhesive sheet at low temperature and room temperature and can increase the adhesive strength of the adhesive sheet. The hydroxyl group-containing (meth)acrylate monomer is not particularly limited, but may be selected from the group consisting of 2-hydroxyethyl methacrylate, hydroxyethyl acrylate, 4-hydroxybutylacrylate, hydroxypropyl (meth)acrylate, and vinyl caprolactam, and may be most preferably 4-hydroxybutylacrylate (4-HBA).

Such hydroxyl group-containing (meth)acrylate monomers have a low curing density and a linear structure and thus can have relatively more appropriate flowability, thereby improving the step absorption with respect to an adherend. In particular, 4-hydroxybutyl acrylate (4-HBA) exhibits quick-drying properties and excellent curability, and thus can improve the adhesion phenomenon caused by uncuring. Accordingly, it serves to reduce differences in the degree of adherence between the resin and the adherend surface, so that an increase in elastic modulus after a thermal process can be reduced, thereby improving folding properties.

The hydroxyl group-containing (meth)acrylate monomer is preferably included in an amount of 8 to 30 wt %, and more preferably 5 to 25 wt %, based on the total weight of the acrylic copolymer. When the content of the hydroxyl group-containing monomer satisfies the above range, it may be advantageous in terms of reactivity with a photopolymerizable (meth)acrylate monomer to be described later. When the content exceeds the above range, the adhesive may absorb excessive moisture and expand in volume, resulting in reduced cohesive strength, which may cause problems such as interfacial peeling and bubble generation.

### B) Crosslinking Agent

The adhesive composition of the present disclosure may further include a crosslinking agent, wherein the crosslinking agent may include, for example, a functional group that reacts with a crosslinkable functional group derived from a crosslinkable group-containing monomer of the (meth)acrylate-based copolymer, thereby improving the cohesive strength or adherence strength of the adhesive composition and maintaining the shape and durability of the adhesive sheet.

The crosslinking agent is not particularly limited and may be any agent known in the art, and preferably, may include at least one selected from metal chelate-based crosslinking agents and isocyanate-based crosslinking agents.

The metal chelate-based crosslinking agent is a component that acts as a catalyst to promote a crosslinking reaction between a hydroxyl group contained in the acrylic copolymer and an isocyanate group contained in the isocyanate-based crosslinking agent, and may have electron-accepting properties.

When the metal chelate-based crosslinking agent and the isocyanate-based crosslinking agent are used as the crosslinking agent of the present disclosure, it is presumed that the reactivity is improved and contamination of an adherend due to residues upon peeling is less likely to occur. In particular, in the present disclosure, since the cohesive strength is improved by using the metal chelate-based crosslinking agent and the isocyanate-based crosslinking agent, when an adhesive sheet is manufactured by subsequent curing and the manufactured adhesive sheet is bonded to a transparent substrate having a water contact angle of 100° or more, the adhesive strength to the transparent substrate is improved, which may be advantageous for folding.

When the isocyanate-based crosslinking agent is included, preferably, at least one selected from the group consisting of tolylene diisocyanate, xylene diisocyanate, hexamethylene diisocyanate, 2,4-diphenylmethane diisocyanate, 4,4-diphenylmethane diisocyanate, isophorone diisocyanate, tetramethylxylene diisocyanate, naphthalene diisocyanate, and isocyanurate trimers may be used. These may be used alone or in a mixture of two or more thereof.

When the metal chelate-based crosslinking agent is included, preferably at least one metal atom selected from zirconium, aluminum, zinc, manganese, and magnesium may be included. More preferably, as the metal chelate-based crosslinking agent, at least one selected from the group consisting of aluminum triacetylacetonate, zirconium tetrakis(acetylacetonate), diisopropoxyaluminum monooleyl acetoacetate, zinc acetylacetone, magnesium acetylacetone, and manganese triacetylacetonate may be used. These may be used alone or in a mixture of two or more thereof.

As the B) crosslinking agent, preferably, at least one selected from an isocyanate crosslinking agent and a metal chelate crosslinking agent is included in an amount of 0.001 to 2 parts by weight, more preferably, 0.001 to 0.5 parts by weight, based on 100 parts by weight of the acrylic copolymer. When the content of the crosslinking agent is less than the above range, the adhesive strength or cohesive strength of the adhesive composition may be somewhat reduced. When the content exceeds the above range, compatibility may be somewhat reduced, resulting in surface migration, and the crosslinking reaction may proceed excessively, resulting in a significant reduction in adhesive strength.

### Plasticizer

The adhesive composition of the present disclosure may further include a plasticizer in order to improve folding properties.

The plasticizer serves to reduce the elastic modulus for improving the folding properties of an adhesive sheet formed using the adhesive composition, while maintaining adherence strength.

According to exemplary embodiments, examples of the plasticizer may include triphenyl phosphate (TPP), tricresyl phosphate (TCP), cresyl diphenyl phosphate, octyl diphenyl phosphate, dioctyl adipate (DOA), biphenyl diphenyl phosphate (BDP), trioctyl phosphate, tributyl phosphate, dimethyl phthalate (DMP), diethyl phthalate (DEP), dibutyl phthalate (DBP), dioctyl phthalate (DOP), diphenyl phthalate (DPP), diethylhexyl phthalate (DEHP), triethyl O-acetyl citrate (OACTE), tributyl O-acetyl citrate (OACTB), acetyl triethyl citrate, acetyl tributyl citrate, butyl oleate, methyl acetyl ricinoleate, dibutyl sebacate, triacetin, tributylin, butylphthalyl glycolate, ethylphthalyl ethyl glycolate, methylphthalyl ethyl glycolate, butylphthalyl butyl glycolate, diisobutyl adipate, and 3-(triethoxysilyl) propyl succinic anhydride. These may be used alone or in combination of two or more thereof, and are not limited thereto.

### Silane Coupling Agent

The adhesive composition of the present disclosure may further include a silane coupling agent. The type of coupling agent is not particularly limited, and any coupling agent commonly known in the field of adhesive manufacture may be used. For example, the silane coupling agent may include gamma-glycidoxypropyl triethoxysilane, gamma-glycidoxypropyl trimethoxysilane, gamma-glycidoxypropyl methyldiethoxysilane, gamma-glycidoxypropyl triethoxysilane, 3-mercaptopropyl trimethoxysilane, vinyltrimethoxysilane, vinyltriethoxysilane, gamma-methacryloxypropyl trimethoxysilane, gamma-methacryloxypropyl triethoxysilane, gamma-aminopropyl trimethoxysilane, gamma-aminopropyl triethoxysilane, or 3-isocyanatopropyl triethoxysilane.

The silane coupling agent may be included in an amount of 0.01 to 1 part by weight based on 100 parts by weight of the acrylic copolymer.

### Additives

The adhesive composition of the present disclosure may further include a tackifier in order to adjust adhesive performance.

In addition, the adhesive composition may further include one or more additives selected from the group consisting of an epoxy resin, a curing agent, a UV stabilizer, an antioxidant, a colorant, a reinforcing agent, a filler, an antifoaming agent, a surfactant, and a plasticizer.

The adhesive composition of the present disclosure may further include a solvent. As the solvent, any solvent known in the art may be used without limitation as long as it is capable of dissolving the monomers and copolymers used in the adhesive composition.

Representative examples of the solvent may include ethyl acetate, methyl ethyl ketone, toluene, and acetonitrile.

The method for preparing the adhesive composition of the present disclosure may be carried out using any method commonly used in the art, except for those described above. In this case, molecular weight modifiers, catalysts, and the like used in the art may also be used without limitation.

The method for applying the adhesive composition of the present disclosure is not particularly limited, and may be performed by general methods such as bar coating, spin coating, comma coating, or gravure coating. During the application process, from the viewpoint of performing a uniform coating process, it is preferable to control the process so that a crosslinking reaction of functional groups of a polyfunctional crosslinking agent included in the adhesive composition does not proceed. Accordingly, the crosslinking agent can form a crosslinked structure during curing and aging processes after coating, thereby improving the cohesive strength, adhesive properties, and cuttability of the adhesive.

In addition, the application process is preferably performed after sufficiently removing bubble-inducing components, such as volatile components or reaction residues, within the adhesive composition. Accordingly, it is possible to prevent phenomena in which bubbles present between a glass plate and the adhesive layer grow at high temperatures and form scattering bodies therein.

The adhesive composition of the present disclosure may be used, for example, for laminating optical films such as a polarizing film, a retardation film, an anti-glare film, a wide viewing angle compensation film, or a brightness enhancement film, or for attaching the optical film, a transparent substrate, or a laminate thereof to an adherend such as a display panel.

### <Adhesive Sheet>

The present disclosure provides an adhesive sheet manufactured by coating the adhesive composition prepared as described above onto a base film. The base film used in the adhesive sheet may include a polyethylene terephthalate film, a polyolefin-based film, a polyester-based film, an acrylic film, a styrene-based film, an amide-based film, a polyvinyl chloride film, a polyvinylidene chloride film, and a polycarbonate film. These films may be appropriately release-treated with silicone-based, fluorine-based, silica powder, or the like, but any film known in the art may be used without limitation. In addition, as the method for manufacturing the adhesive sheet, any method known in the art may be used without limitation.

In one or more embodiments, the adhesive sheet may be manufactured through a process in which the adhesive is applied onto the base film and thermally cured. Thermal curing may be formed by coating the adhesive composition onto the base film. The coating method is not particularly limited as long as it is known in the art, and for example, a bar coater, air knife, gravure, reverse roll, kiss roll, spray, blade, die coater, casting, spin coating, etc. may be used. Specifically, the adhesive sheet may be formed by applying and drying the adhesive composition on the base film, followed by curing through irradiation with ultraviolet rays or the like.

The adhesive sheet formed from the adhesive composition of the present disclosure may have an adhesive strength of 100 to 300 gf/inch, preferably 150 to 250 gf/inch. In particular, the adhesive sheet formed from the adhesive composition of the present disclosure may have an adhesive strength of 100 to 300 gf/inch to a substrate having a water contact angle of 100° or more. Within the above range, the adhesive sheet can be stably attached to the substrate, reliability can be enhanced, and layer separation during folding can be prevented. When the adhesive strength exceeds the above preferred range, the adhesive composition may tend to remain on the adherend upon re-peeling, thereby causing contamination.

In addition, the adhesive sheet formed from the adhesive composition of the present disclosure may have an elastic modulus of 30 to 300 kPa at −20° C. An adhesive sheet satisfying the above characteristics exhibits a low low-temperature elastic modulus and excellent recovery rate, which not only improves folding properties but also facilitates re-peelability. When the elastic modulus exceeds the above preferred range, the restoring force of a step cannot be suppressed, resulting in fracture, lifting, or wrinkling during folding.

Considering the tendency that adhesive strength increases as the elastic modulus increases, since folding properties are properties that are manifested as the elastic modulus decreases, it is difficult to achieve the folding properties solely with high adhesive strength. Conversely, although a low elastic modulus is advantageous for folding properties, insufficient adhesive strength may cause lifting. In addition, folding properties are values derived from a combination of adhesive strength and recovery rate, and cannot be predicted by only one of the two factors. However, the adhesive sheet according to the present embodiment has excellent restoring force, and thus may not develop wrinkles or the like even when the adhesive sheet is restored to its original state after long-term folding. Moreover, the adhesive sheet exhibits good folding properties at both room temperature and low temperature, and thus may be used in flexible display devices.

### <Protective Film>

In manufacturing and processing processes of optical members (optical materials) including optical films such as polarizers, retardation films, and anti-reflection films, a surface protective film may be attached to the surface of the optical member for the purposes of preventing surface scratches, preventing contamination, improving cutting processability, and suppressing cracking, etc. Such a protective film may be manufactured by bonding an adhesive sheet, which is produced using an adhesive composition, to one surface of a transparent substrate. In particular, the adhesive sheet may exhibit excellent adherence to the transparent substrate included in the protective film of the present disclosure.

The protective film is especially required to have excellent peelability (re-peelability), because peeling and replacement are frequently required in flexible displays, which are more prone to fracture, lifting, and wrinkling than other displays. Furthermore, the protective film is required to exhibit sufficient adhesive properties and folding properties while attached. In addition, in order to prevent components contained in the adhesive from contaminating the surface of the adherend after peeling and thereby significantly adversely affecting optical properties, the protective film is required to be easily re-peelable while having excellent adhesive strength. As such, the adhesive sheet used in the protective film is required to have adequate re-peelability, adhesive strength, and folding properties simultaneously.

However, conventional protective films, particularly fluororesin films and polyimide films, have excellent processability as materials for flexible displays, but have drawbacks in that they are poorly compatible with general-purpose adhesives or adhesive layers formed therefrom and are difficult to adhere thereto. Accordingly, since the adhesive sheet according to the present disclosure exhibits excellent adherence to a transparent substrate having a water contact angle of 100° or more, a protective film may be formed by bonding the adhesive sheet of the present disclosure to one surface or both surfaces of the transparent substrate. Specifically, the present disclosure may provide a protective film including the adhesive sheet of the present disclosure and a transparent substrate having a water contact angle of 100° or more. For example, the transparent substrate having a water contact angle of 100° or more may be coated with a fluororesin; but resin films, polyethylene terephthalate films, polyimide films, and transparent substrates coated with materials developed in the future may also be used. When a protective film is formed using the above-described adhesive sheet, it is possible to manufacture a protective film that is particularly easy to re-peel and has excellent folding properties.

The water contact angle refers to an angle formed by a water droplet on the surface of the protective film when the water droplet is dropped on the surface. As the water contact angle increases, foreign substances are less likely to adhere to the coated surface, thereby providing superior antifouling properties such as fingerprint resistance. For example, in the case of a fluorine-coated transparent substrate, an increase in surface orientation of the fluorine material due to a fluorine-based solvent can improve not only the initial antifouling performance but also the maintenance of the antifouling performance, i.e., abrasion resistance.

In summary, the protective film according to the present disclosure may have a water contact angle of 100° or more, and thus has advantages of excellent abrasion resistance and antifouling properties.

### <Display Device>

The present disclosure provides a display device including an adhesive sheet formed from the adhesive composition of the present disclosure.

The display device may be a flexible display device, and more preferably may be a foldable display.

Hereinafter, the present disclosure will be described in more detail by way of examples and comparative examples. However, the following examples are provided merely to illustrate the present disclosure, and the present disclosure is not limited by the following examples and may be variously modified and changed.

### Preparation Example: Preparation of Acrylic Copolymer

### Preparation Example 1: Acrylic Copolymer A-1

Into a 1 L reactor equipped with a nitrogen gas reflux system and a cooling device for easy temperature control were introduced 80 wt % of 2-ethylhexyl acrylate (2-EHA), 10 wt % of isodecyl acrylate (IDA), 0.2 wt % of acrylic acid (AA), and 9.8 wt % of 4-hydroxybutyl acrylate (4-HBA), and then 100 parts by weight of ethyl acetate (EA) as a solvent were added. Thereafter, nitrogen gas was introduced for 1 hour to purge oxygen, and the temperature was maintained at 62° C. After uniformly stirring the mixture, 0.07 parts by weight of azobisisobutyronitrile (AIBN) as a reaction initiator was added, and the reaction was carried out for 8 hours to prepare an acrylic copolymer A-1 having a weight average molecular weight of 1.13 million or more.

### Preparation Example 2: Acrylic Copolymer A-2

In the same manner as in Preparation Example 1, 75 wt % of 2-ethylhexyl acrylate (2-EHA), 15 wt % of stearyl acrylate (SA), 0.5 wt % of acrylic acid (AA), 5.5 wt % of 4-hydroxybutylacrylate (4-HBA), and 4 wt % of 6-hydroxyhexyl acrylate (6-HHA) were used to prepare acrylic copolymer A-2 having a weight average molecular weight of 1.2 million or more.

### Preparation Example 3: Acrylic Copolymer A-3

In the same manner as in Preparation Example 1, 69.9 wt % of 2-ethylhexyl acrylate (2-EHA), 20 wt % of 2-decyl-1-tetradecenyl acrylate (DTD-A), 0.1 wt % of 2-carboxyethyl acrylate (2-CEA), and 10 wt % of 4-hydroxybutyl acrylate (4-HBA) were used to prepare an acrylic copolymer A-3 having a weight average molecular weight of 1.09 million or more.

### Preparation Example 4: Acrylic Copolymer A-4

In the same manner as in Preparation Example 1, 60 wt % of n-butyl acrylate (BA), 30 wt % of 2-ethylhexyl acrylate (2-EHA), 0.2 wt % of acrylic acid (AA), and 9.8 wt % of 4-hydroxybutyl acrylate (4-HBA) were used to prepare an acrylic copolymer A-4 having a weight average molecular weight of 1.10 million or more.

### Preparation Example 5: Acrylic Copolymer A-5

In the same manner as in Preparation Example 1, 75.1 wt % of 2-ethylhexyl acrylate (2-EHA), 5 wt % of 2-decyl-1-tetradecenyl acrylate (DTD-A), 0.1 wt % of acrylic acid (AA), 10 wt % of acryloyl morpholine, and 9.8 wt % of 4-hydroxybutyl acrylate (4-HBA) were used to prepare an acrylic copolymer A-5 having a weight average molecular weight of 1.12 million or more.

### EXAMPLES AND COMPARATIVE EXAMPLES

An adhesive composition was prepared by mixing the components and contents as shown in Table 1 below and diluting the mixture with an organic solvent in consideration of coating properties. Here, the contents are in parts by weight. The prepared adhesive composition was applied onto a film coated with a silicone release agent so as to have a thickness of 25 μm after drying, and dried at 100° C. for 5 minutes to form an adhesive sheet.

TABLE 1

| | Acrylic copolymer | | Crosslinking agent | | | | Additives |
|---|---|---|---|---|---|---|---|
| Division | Type | Content | Type | Content | Type | Content | C |
| Example 1 | A-1 | 100 | B-1 | 0.05 | B-4 | 0.02 | |
| Example 2 | A-1 | 100 | B-2 | 0.05 | B-4 | 0.02 | |
| Example 3 | A-1 | 100 | B-3 | 0.1 | B-4 | 0.03 | |
| Example 4 | A-2 | 100 | B-3 | 0.2 | B-5 | 0.02 | |
| Example 5 | A-2 | 100 | — | — | B-4 | 0.05 | |
| Example 6 | A-3 | 100 | B-2 | 0.1 | B-5 | 0.01 | |
| Example 7 | A-3 | 100 | B-3 | 0.3 | | | |
| Example 8 | A-3 | 100 | B-3 | 0.05 | B-4 | 0.1 | |
| Example 9 | A-3 | 100 | B-2 | 0.05 | B-4 | 0.02 | 3 |
| Comparative | A-1 | 100 | B-2 | 3.5 | | | |
| Example 1 | | | | | | | |
| Comparative | A-2 | 100 | B-2 | 0.05 | B-4 | 3 | |
| Example 2 | | | | | | | |
| Comparative | A-4 | 100 | B-2 | 0.05 | B-4 | 0.02 | |
| Example 3 | | | | | | | |
| Comparative | A-5 | 100 | B-2 | 0.05 | B-4 | 0.02 | |
| Example 4 | | | | | | | |

A-1 to A-5: Acrylic copolymers prepared according to Preparation Examples 1 to 5
B-1: Aluminum triacetylacetonate
B-2: Diisopropoxyaluminum monooleyl acetoacetate
B-3: Zirconium tetrakis(acetylacetonate)
B-4: D-103, Mitsui Chemicals (TDI-based isocyanate)
B-5: D-110N, Mitsui Chemicals (XDI-based isocyanate)
C: DOA, Aekyung Chemical

### Test Example: Evaluation of Properties of Adhesive Composition

The properties of the adhesive sheets manufactured in the Examples and Comparative Examples were measured by the following methods, and the results are shown in Table 2 below.

### 1. Measurement of Adhesive Strength

Each of the adhesive sheets manufactured in the Examples and Comparative Examples was cut into a size of 25 mm×100 mm to prepare specimen. The release film was peeled off from the prepared specimen, which was then laminated onto a fluorine-coated surface of PET having a water contact angle of 109°, followed by autoclave treatment to prepare a test specimen. Room-temperature adhesive strength was measured by allowing the prepared specimen to stand for 24 hours under conditions of 23° C. and 50% RH, and then peeling the adhesive layer using a universal testing machine (UTM, Instron) at a peel speed of 300 mm/min and a peel angle of 180°. The measurement was carried out under conditions of 23° C. and 50% RH.

### 2. Evaluation of Elastic Modulus

For each of the adhesive sheets manufactured in the Examples and Comparative Examples, the storage modulus was measured.

The adhesive sheet was laminated to a thickness of 1000 μm and cut into a circular specimen having a diameter of 8 mm. The storage modulus was measured using a viscoelasticity measuring device (MCR-301, Anton Paar). Measurements were performed in a temperature range of −30 to 100° C. under conditions of a frequency of 1.0 Hz, a strain of 1%, and a heating rate of 5° C., and the measured value at −20° C. was read.

### 3. Measurement of Recovery Rate

Specimens were prepared in the same manner as those used for the elastic modulus measurement. The values measured using an MCR-301 equipment were used to calculate the recovery rate according to Equation 1.
Test temperature: 25° C.
Shear stress: 1000 Pa
Creep time: 300 seconds
Recovery time: 300 seconds

$$Recovery rate ( \% ) = ( 1 - creep strain / recovery strain ) \times 100 \qquad 〈 Equation 1 〉$$

### 4. Evaluation of Folding Properties

The adhesive sheets prepared in the Examples and Comparative Examples were bonded to 50 μm PET and cut into 20 mm×100 mm pieces, which were used as specimens.

Each specimen was fixed to a flexibility evaluation device for folding evaluation (COVOTECH, CFT-720C), and folding was performed with a curvature radius of 2 mm under conditions of 25 foldings per minute and a holding time of 0.2 seconds after each folding. Folding evaluation was carried out under conditions of −20° C. or 60° C. and 90% RH. In the folding evaluation, one folding was defined as one cycle. After performing 30,000 folding cycles, the specimens were evaluated as follows: if stripes occurred at the folding portion, or if fracture, lifting, or peeling of the protective film occurred, the specimens were evaluated as X; if breakage, lifting, or peeling occurred with a size of 0.3 mm or less, the specimens were evaluated as ∘; and if no problem occurred at all, the specimens were evaluated as ⊚.
⊚: No defects occurred after 50,000 or more folding cycles
∘: Defects occurred in a folding cycle range of 20,000 or more and less than 50,000
x: Defects occurred in less than 20,000 folding cycles

TABLE 2

| | | | | Folding | |
|---|---|---|---|---|---|
| | | | | properties | |
| | | −20° C. | Reco- | | 60° |
| | Adhesive | Elastic | very | | C., |
| | strength | modulus | rate | −20° | RH |
| Division | [gf/inch] | [KPa] | [%] | C. | 90% |
| Exam- | 156 | 102.0 | 92.8 | ○ | ⊚ |
| ple 1 | | | | | |
| Exam- | 176 | 98.7 | 92.3 | ○ | ⊚ |
| ple 2 | | | | | |
| Exam- | 185 | 97.5 | 91.4 | ⊚ | ○ |
| ple 3 | | | | | |
| Exam- | 163 | 97.7 | 91.9 | ⊚ | ⊚ |
| ple 4 | | | | | |
| Exam- | 198 | 105 | 90.5 | ○ | ⊚ |
| ple 5 | | | | | |
| Exam- | 169 | 71.6 | 92.8 | ○ | ○ |
| ple 6 | | | | | |
| Exam- | 158 | 66.4 | 93.4 | ⊚ | ⊚ |
| ple 7 | | | | | |
| Exam- | 221 | 70.4 | 90.5 | ⊚ | ⊚ |
| ple 8 | | | | | |
| Exam- | 206 | 68.5 | 91.2 | ⊚ | ○ |
| ple 9 | | | | | |
| Com- | 43 | 97.5 | 92.3 | x | x |
| para- | | | | | |
| tive | | | | | |
| Exam- | | | | | |
| ple 1 | | | | | |
| Com- | 51 | 100.2 | 91.2 | x | x |
| para- | | | | | |
| tive | | | | | |
| Exam- | | | | | |
| ple 2 | | | | | |
| Com- | 210 | 552 | 85.2 | x | x |
| para- | | | | | |
| tive | | | | | |
| Exam- | | | | | |
| ple 3 | | | | | |
| Com- | 185 | 432 | 79.1 | x | x |
| para- | | | | | |
| tive | | | | | |
| Exam- | | | | | |
| ple 4 | | | | | |

As confirmed from the test results shown in Tables 1 and 2, the adhesive sheet manufactured from the adhesive composition of the Examples of the present disclosure uses an adhesive composition including a metal crosslinking agent and an isocyanate-based crosslinking agent in a preferred range, and thus satisfies an adhesive strength of 100 to 300 gf/inch to a transparent substrate having a water contact angle of 100° or greater, thereby exhibiting easy re-peelability and excellent adhesive strength. In addition, the adhesive sheet of the present disclosure includes a linear or branched (meth)acrylate monomer having 8 to 30 carbon atoms within a preferred range, and thus satisfies an elastic modulus of 30 to 300 kPa at −20° C., thereby exhibiting excellent folding properties. In particular, the folding properties were confirmed to be remarkably superior compared to those of the adhesive compositions of the Comparative Examples.

In the cases of Comparative Examples 1 and 2, although a preferred acrylic copolymer was included, the content of the isocyanate-based crosslinking agent exceeded the preferred range, so that the crosslinking reaction proceeded excessively. As a result, adhesive strength was reduced and failed to satisfy 100 to 300 gf/inch, which may cause fracture and make re-peeling difficult. Therefore, although the elastic modulus satisfied 30 to 300 kPa and the recovery rate was excellent, the folding properties were very poor.

In addition, in the case of Comparative Example 3, since the content of the linear or branched (meth)acrylate monomer having 8 to 30 carbon atoms was below the preferred range, the low-temperature elastic modulus was excessively high. As a result, the recovery rate was low, and even though the adhesive strength satisfied 100 to 300 gf/inch, the folding properties were very poor.

In addition, in the case of Comparative Example 4, since an amine monomer was included, the low-temperature elastic modulus was excessively high. Therefore, the recovery rate was significantly low, and even though the adhesive strength satisfied 100 to 300 gf/inch, the folding properties were not good.

What is claimed is:

1. An adhesive composition comprising: A) an acrylic copolymer and B) a crosslinking agent,
wherein the A) acrylic copolymer includes a linear or branched alkyl (meth)acrylate monomer having 8 to 30 carbon atoms in an amount of 73 to 94.99 wt % based on the total weight of the acrylic copolymer,
the B) crosslinking agent includes at least one selected from an isocyanate crosslinking agent and a metal chelate crosslinking agent in an amount of 0.001 to 2 parts by weight based on 100 parts by weight of the acrylic copolymer, and
the A) acrylic copolymer does not include an amine monomer.

2. The adhesive composition of claim 1, wherein the isocyanate crosslinking agent includes at least one selected from the group consisting of tolylene diisocyanate, xylene diisocyanate, hexamethylene diisocyanate, 2,4-diphenylmethane diisocyanate, 4,4-diphenylmethane diisocyanate, isophorone diisocyanate, tetramethylxylene diisocyanate, naphthalene diisocyanate, and isocyanurate trimers.

3. The adhesive composition of claim 1, wherein the metal chelate crosslinking agent includes at least one selected from zirconium, aluminum, zinc, manganese, and magnesium.

4. The adhesive composition of claim 1, wherein the metal chelate crosslinking agent includes at least one selected from the group consisting of aluminum triacetylacetonate, zirconium tetrakis(acetylacetonate), diisopropoxyaluminum monooleyl acetoacetate, zinc acetylacetone, magnesium acetylacetone, and manganese triacetylacetonate.

5. The adhesive composition of claim 1, wherein the linear or branched alkyl (meth)acrylate monomer having 8 to 30 carbon atoms includes at least one selected from the group consisting of ethylhexyl acrylate (2-EHA), 2-dodecyl-1-hexadecenyl acrylate (DHD-A), 2-decyl-1-tetradecenyl acrylate (DTD-A), lauryl acrylate, and stearyl acrylate.

6. The adhesive composition of claim 1, wherein the A) acrylic copolymer includes an acid-containing (meth)acrylate monomer in an amount of 0.01 to 2 wt % based on the total weight of the acrylic copolymer.

7. The adhesive composition of claim 1, wherein the A) acrylic copolymer includes a hydroxyl group-containing (meth)acrylate monomer in an amount of 5 to 25 wt % based on the total weight of the acrylic copolymer.

8. The adhesive composition of claim 7, wherein the hydroxyl group-containing (meth)acrylate monomer includes 4-hydroxybutyl acrylate (4-HBA).

9. An adhesive sheet manufactured by coating the adhesive composition of claim 1 onto a base film.

10. The adhesive sheet of claim 9, wherein the adhesive sheet has an adhesive strength of 100 to 300 gf/inch as measured at 23° C. and 50% RH after being bonded to a substrate having a water contact angle of 100° or more.

11. The adhesive sheet of claim 9, wherein the adhesive sheet has an elastic modulus of 30 to 300 kPa at −20° C.

12. A display device comprising the adhesive sheet of claim 9.

13. The display device of claim 12, wherein the display device comprises a foldable display device.
